(19) United States
(12) Patent Application Publication
(10) Pub. No.: US 2022/0281327 A1
(43) Pub. Date: Sep. 8, 2022

(54) Self Powered EV System

(71) Applicant: Alexander Diaz, Rochester, NY (US)

(72) Inventor: Alexander Diaz, Rochester, NY (US)

(21) Appl. No.: 17/194,260

(22) Filed: Mar. 7, 2021

(51) Int. Cl. B60L 50/15

(52) U.S. Cl. CPC B60L 50/15

(57) ABSTRACT

A self powered system for EV's using kinetic energy from the non motorized wheels. Rotation/Motion from the non motorized wheels is transferred via shafts to gearboxes which increases the rotational speed, this energy is then transferred via high speed shafts into alternators. The alternators then converts this energy to electricity which is sent to the vehicles 12 v battery, the ignition, and to DC/DC converters. The DC/DC converters increases the voltage output to charge the high voltage battery. The system also contains a separate charge port with an AC/DC converter for additional charging options. Electricity stored in the high voltage battery goes through DC/AC inverter(s) to power the electric motor(s). The electric motor(s) then turns the differential creating propulsion via the remaining wheel(s).

### BRIEF DESCRIPTION OF THE FIGURES

FIG. 1 is a schematic top elevation view for illustrative purposes of a self powered system using kinetic energy for dual electric motors vehicle;

FIG. 2 is a schematic top elevation view for illustrative purposes of a self powered system using kinetic energy for single electric motor vehicle.

### DETAILED DESCRIPTION OF FIGURES

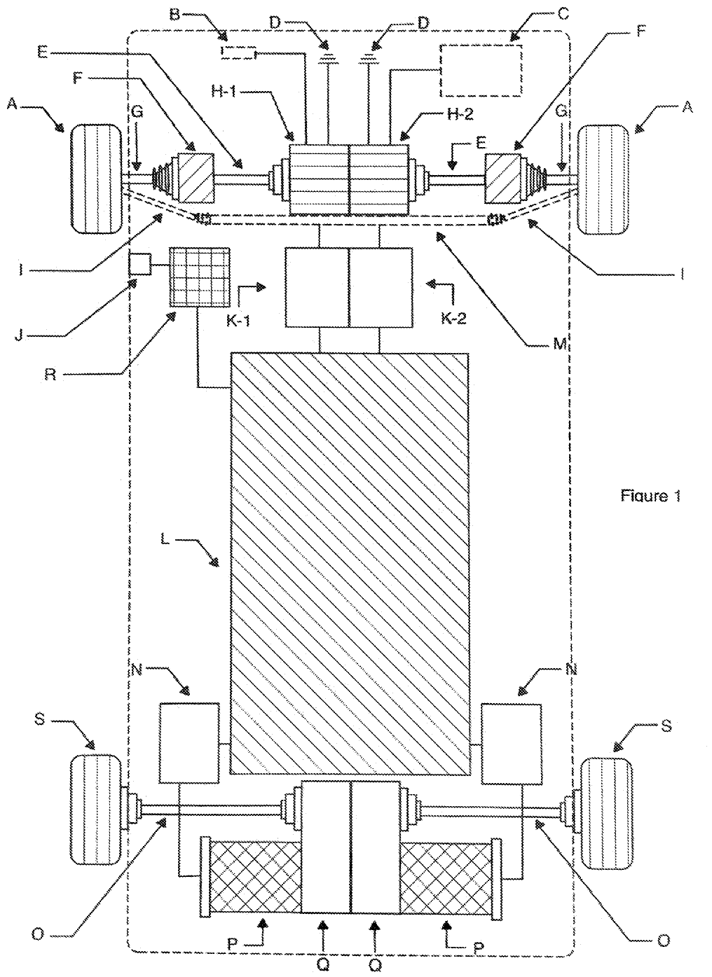

FIG. 1

In FIG. 1 you can see how a dual electric motors vehicle can power itself using kinetic energy. The system uses the electricity stored in the high voltage battery (L) for initial propulsion. When the front wheels are in motion it transfers kinetic energy from the front wheels (A) via shafts (G) gearbox(es) (F) which increases the rotational speed. This energy then goes through high speed shafts (E) and into alternators (H-1, H-2). The alternators (H-1, H-2) then converts the kinetic energy into electricity. While either alternators (H-1,H-2) can be used to send electricity to charge the vehicles 12 v battery (C) or power the ignition switch (B), both alternators (H-1, H-2) electricity is sent through DC/DC converters (K-1, K-2) increasing voltage output for charging the vehicle's high voltage battery (L). The high voltage battery (L) also has a separate charge port (J) with an AC/DC converter (R) for additional charging options. The electricity stored in the high voltage battery (L) then goes through a DC/AC inverter(s) (N) to power the electric motor(s) (P). The electric motor(s) (P) then turns the differential(s) (Q) creating propulsion via rear wheels (S).

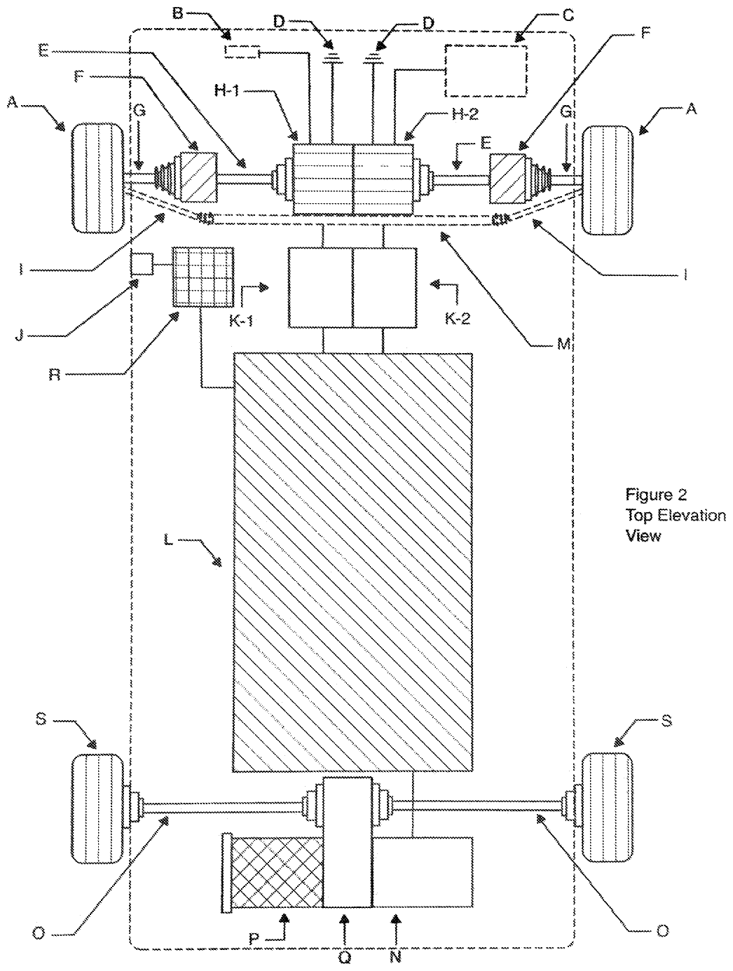

FIG. 2

In FIG. 2 you can see how a single electric motor vehicle can power itself using kinetic energy. The system uses the electricity stored in the high voltage battery (L) for initial propulsion. When the front wheels are in motion it transfers kinetic energy from the front wheels (A) via shafts (G) to gearbox(es) (F) which increases the rotational speed. This energy then goes through high speed shafts (E) and into alternators (H-1, H-2). The alternators (H-1, H-2) then converts the kinetic energy into electricity. While either alternators (H-1,H-2) can be used to send electricity to charge the vehicles 12 v battery (C) or power the ignition switch (B), both alternators (H-1, H-2) electricity is sent through DC/DC converters (K-1, K-2) increasing voltage output for charging the vehicle's high voltage battery (L). The high voltage battery (L) also has a separate charge port (J) with an AC/DC converter (R) for additional charging options. The electricity stored in the high voltage battery (L) then goes through a DC/AC inverter(s) (N) to power the electric motor(s) (P). The electric motor(s) (P) then turns the differential(s) (Q) creating propulsion via rear wheels (S).

### LEGEND

A. Front Wheels
B. Ignition Switch
C. 12 v Battery
D. Ground Cables
E. High Speed Shafts
F. Gearboxes
G. Front Axle Shafts
H-1. Alternator
H-2. Alternator
I. Tie Rods
J. Charge Port
K-1. DC/DC Converter
K-2. DC/DC Converter
L. High Voltage Battery
M. Rack and Pinion
N. DC/AC Inverter(s)/Controller (s)
O. Rear Axles
P. Electric Motor(s)
Q. Rear Differential(s)
R. AC/DC Converter
S. Rear Wheels

### REFERENCE

U.S. Pat. No. 10,696,149
Date of patent: Jun. 30, 2020
Integrated Electric Motor Assembly
Testa, Inc.

1. A self powered system using kinetic energy to power the electric motor(s) on a vehicle comprising:
(a) capturing kinetic energy from wheel(s) and transferring such energy to gearbox(es) via a shaft(s) to
(b) increase rotational speed with the use of gearbox(es) and
(c) sending such energy from gearbox(es) to an alternator via a high speed shaft(s)
(d) these high speed shaft(s) drives the alternator(s) to create electricity
(e) said electricity is sent to ignition and/or 12 v battery and to DC/DC converter(s) to increase voltage
(f) the increased voltage from DC/DC converter(s) is then sent via power cables to charge the high voltage battery(ies)
(g) power then goes from the high voltage battery(ies) to DC/AC inverter(s) and
(h) used to power the electric motor(s) of the vehicle for propulsion
and with such extending the miles range of the vehicle.
